(19) United States
(12) Patent Application Publication
(10) Pub. No.: US 2011/0259616 A1
(43) Pub. Date: Oct. 27, 2011

(54) Method and apparatus for automatically extinguishing fires on or in the surrounding area of the wind energy installation

(75) Inventor: Matthias Stommel, Ganderkesee (DE)

(73) Assignee: Volkswind GmbH, Ganderkesee (DE)

(21) Appl. No.: 12/873,594

(22) Filed: Sep. 1, 2010

(30) Foreign Application Priority Data
Sep. 11, 2009 (DE) 102009040920.3

(51) Int. Cl. A62C 3/02; A62C 35/11; A62C 31/00

(52) U.S. Cl. 169/46; 169/60; 169/61

(57) ABSTRACT

The invention relates to a method and an apparatus for automatically extinguishing fires on a wind energy installation or in the surrounding area of the wind energy installation, in which the wind energy installation (10) and/or the surrounding area of the wind energy installation (10) are/is monitored for the occurrence of a fire (32) by means of a suitable detection device, and in which, after the detection of a corresponding fire (32), an extinguishant (26), preferably water, is passed out of an extinguishant reservoir (28), which is associated with the wind energy installation (10), in the direction of the fire location.

### BACKGROUND OF THE INVENTION

1. Technical Field

The present invention relates to a method for automatically extinguishing fires on a wind energy installation or in the surrounding area of the wind energy installation, and to a wind energy installation which is equipped with a corresponding apparatus for automatic extinguishing.

2. Prior Art

Currently, wind energy installations are increasingly being planned even in wooded areas. Wind energy installations create potential fire hazards, of course, like any technical facility. Various components of the installation can be set on fire, for example by short circuits in transformers in the installation, power electronics or the like. Furthermore, there is a risk of fire from lightning strikes in the installation or simply caused by maintenance personnel, who can accidentally cause fires. Fires such as these in wind energy installations can result in fires in the surrounding wood, with fatal consequences, of course. Conversely, wind energy installations installed in wooded areas are, of course, also themselves at risk of being set on fire by woodland fires not caused by them.

### BRIEF SUMMARY OF THE INVENTION

Against this background one object of the present invention is to specify a method of the type mentioned initially for extinguishing fires on wind energy installations or fires in the surrounding area thereof. A further object of the invention is to specify a wind energy installation having a corresponding apparatus, by means of which such fires can be extinguished.

This object is achieved by a method for automatically extinguishing fires on a wind energy installation or in the surrounding area of a wind energy installation, in which the wind energy installation and/or the surrounding area of the wind energy installation are/is monitored for the occurrence of a fire by means of a suitable detection device, and by means of which, after the detection of a corresponding fire, an extinguishant, preferably water, is passed out of an extinguishant reservoir, which is associated with the wind energy installation, in the direction of the fire location, and a wind energy installation having an apparatus for automatically extinguishing fires on the wind energy installation or in the surrounding area of the wind energy installation, in particular for carrying out the method of the present invention, having a detection device by means of which the wind energy installation and/or the surrounding area of the wind energy installation can be monitored for the occurrence of a fire, and having a reservoir, which is associated with the wind energy installation, for an extinguishant, from which the extinguishant can be passed automatically in the direction of the fire location after detection of a corresponding fire.

A wind energy installation accordingly has an apparatus for automatically extinguishing fires which apparatus, according to the invention, first of all monitors the wind energy installation and/or the surrounding area of the wind energy installation for the occurrence of a fire, by means of a suitable detection device. After detection of a fire such as this, the extinguishing apparatus automatically initiates extinguishing measures. For this purpose, an extinguishant, preferably water, is passed out of an extinguishant reservoir, which is associated with the wind energy installation, in the direction of the fire location, in order to extinguish the fire.

In this case, a fire can be detected in many different ways by sensors.

One or more thermal imaging cameras is or are preferably used according to the invention in order to detect fires outside the wind energy installation, that is to say at a distance from the tower thereof, and in particular in the relatively close surrounding area of the wind energy installation. The respective thermal imaging camera can in this case be mounted, for example, at a suitable height directly on the tower of the installation and can monitor small or relatively large areas of the installation surrounding area, depending on its detection angle.

It is also feasible to detect fires within the tower of the wind energy installation. Thermal imaging cameras are also in principle suitable for this purpose. Alternatively or additionally, fire alarms or the like can also be used.

After detection of a fire in the installation or in the surrounding area thereof, the extinguishant can then be passed automatically from the extinguishant reservoir in the direction of the fire source.

The extinguishant reservoir that is used is preferably a container like a tank. The extinguishant is generally water. This is particularly appropriate when the aim is to extinguish fires in the surrounding area or in the vicinity of the installation. In contrast, fires in the interior of the installation can advantageously also be extinguished using different extinguishants, for example extinguishing powder, extinguishing foam or the like.

In a further advantageous embodiment of the invention, the extinguishant reservoir is arranged within the tower of the wind energy installation, for example in the area of the base of the tower. However, it is also feasible to arrange the extinguishant reservoir at a certain distance from the tower. In this case, in principle, the extinguishant reservoir can be positioned at least partially, and preferably completely, under or above the surrounding ground surface.

In one particularly preferred embodiment of the invention, a rainwater cistern is incorporated in the ground adjacent to the tower of the wind energy installation.

Rainwater which, for example, has run off the tower of the wind energy installation can then enter the cistern through appropriate openings in the cistern arranged in the ground. For this purpose, the cistern is directly adjacent to the installation tower, or may be positioned at a short horizontal distance away from it.

In principle, the cistern can at the same time be used as the extinguishant reservoir, from which, in the event of a fire, the rainwater is passed directly in the direction of the respective fire locations. Alternatively, rather, the cistern can also be used as a type of separate intermediate reservoir, from which the rainwater which has been collected is first of all supplied to the actual extinguishant reservoir, from which the fires are then extinguished. In this case, the rainwater is expediently fed to the extinguishant reservoir by a suitable feed device, for example by means of one or more pumps.

There are various options for feeding the extinguishant to the fire locations.

In order to extinguish fires which occur in the surrounding area of the wind energy installation, for example relatively small wood or shrubbery fires, it is preferable according to the invention to position the extinguishant reservoir higher than the potential fire sources arranged in the surrounding area of the reservoir, for example the bushes, trees or the like. It is positioned such that, after detection of a corresponding fire, extinguishant, in this case liquid extinguishant, can flow out of the extinguishant reservoir along a gradient in the direction of the fire sources, which are arranged further below.

For this purpose, the extinguishant reservoir is preferably positioned or installed on a raised area within a terrain area of appropriate shape, in which the extinguishant reservoir is arranged. In general, the extinguishant reservoir is in this case furthermore arranged within the tower of the wind energy installation, such that the wind energy installation together with the tower will be positioned on the raised area.

The raised area may be a natural raised area or an artificially created raised area. In other words, in the latter case, a raised area is created in the terrain area in which the wind energy installation is intended to be installed, and complies with the requirements described above. This can be done, for example, by appropriate mounds or the like. The extinguishant reservoir and/or the wind energy installation together with the tower are then installed on the raised area.

After detection of a fire below said raised area, the liquid extinguishant can then be passed out of the extinguishant reservoir. The extinguishing water in consequence flows along the terrain gradient, starting from the extinguishant reservoir, to the fire sources which are arranged further below. In other words, the surrounding area of the wind energy installation in which fires occur is flooded at least in places with the liquid extinguishant, in order to extinguish these fires.

In order to control the flow of the extinguishant out of the extinguishant reservoir in the event of a fire, the extinguishant reservoir has at least one associated controllable valve by means of which an outlet-flow opening, which is associated with the extinguishant reservoir, can be closed or opened, through which the extinguishant can flow out of the extinguishant reservoir in the event of a fire and can be supplied to the fire locations.

In this case, the controllable valve can be controlled automatically by means of a suitable electronic control device. The control device expediently receives a suitable signal from the detection device, after it has detected a fire. The control device then opens said valve.

In a further embodiment of the invention, an emergency power supply is provided, which supplies all the electrically powered components of the extinguishing apparatus with electrical power for automatically extinguishing the fires, even, for example, when the main power supply fails.

According to the invention, it is also possible for the extinguishing apparatus to be monitored and/or to be maintained by means of remote monitoring, by remote data transmission.

### BRIEF DESCRIPTION OF THE DRAWINGS

Further features of the invention will become evident from the attached dependent claims, from the following description of one preferred exemplary embodiment, and from the attached drawing, in which:

FIG. 1 shows an outline sketch of a wind energy installation with an apparatus according to the invention for extinguishing fires in the surrounding area of the installation.

### DETAILED DESCRIPTION OF PREFERRED EMBODIMENTS

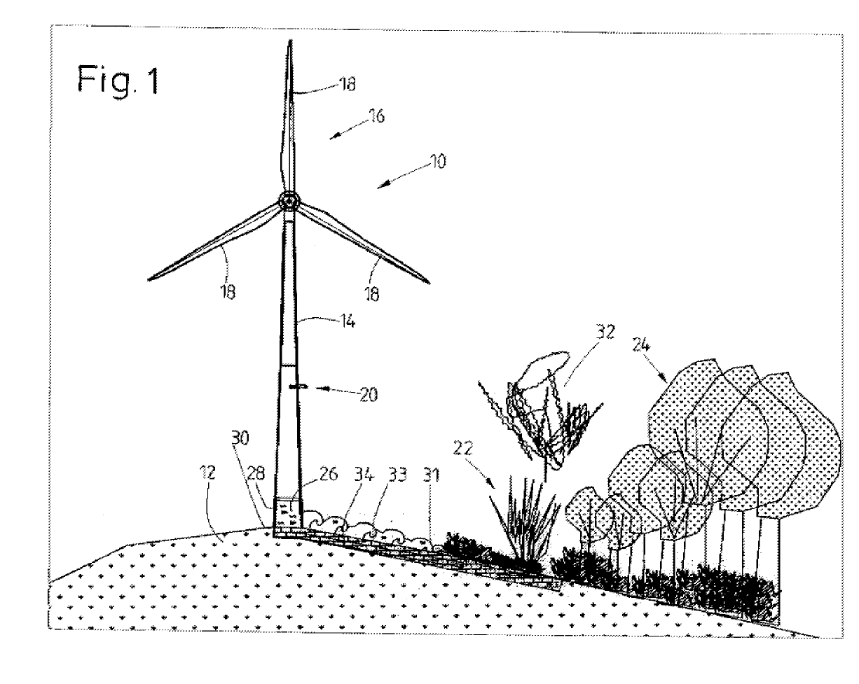

FIG. 1 shows a wind energy installation 10. The wind energy installation 10 has a pod, which is arranged on the top of a vertical tower 14, at the upper end of the tower, which is arranged on ground 12. As a person skilled in the prior art knows, many embodiments are feasible for the detailed design of a tower 14 of a wind energy installation 10. In the present case, the tower 14 has a truncated conical shape.

A rotor 16 with three rotor blades 18 is arranged at an end of the pod facing the wind and is connected in a manner known per se to a rotor hub.

With an appropriate wind, the rotor 18 rotates about an axis which is inclined slightly upward to the horizontal. The movement of the rotor shaft is converted to electrical power by a generator arranged within the pod. The wind energy installation 10 is connected to an electrical grid cistern, into which the electrical energy produced by the generator can be fed.

The fundamental design of the wind energy installation 10 is known from the prior art, and will therefore not be described in any more detail.

Furthermore, the wind energy installation 10 has an apparatus for automatically extinguishing fires which occur in the surrounding area of the installation 10.

Additionally or alternatively, it is also feasible to extinguish fires on, and in particular within, the installation 10.

The apparatus for extinguishing fires has a detection device by means of which fires can be identified. In the present case, the detection device comprises a thermal imaging camera 20 which is installed at an adequate height on the outside of the tower 14.

The installation height relative to the ground 12 is chosen such that the camera 20 can monitor as large an area as possible in the surrounding area of the installation 10. The installation 10 is installed within a wooded area, specifically adjacent to and in this case at a certain distance from shrubbery 22 and trees 24. Fires in this shrubbery 22 and in these trees 24 can be identified, and can then be automatically extinguished, by means of the apparatus according to the invention and the corresponding method according to the invention.

For this purpose, the thermal imaging camera 20 is aligned such that it can cover the shrubbery 22 and trees 24. Corresponding fire sources in the area of the shrubbery 22 and trees 24 can be recorded by the thermal imaging camera 20, and can be identified by means of a suitable evaluation unit in the detection device. In the present case, an evaluation unit such as this is installed directly in the camera unit. The camera unit can also, of course, just as well be restricted exclusively to recording the corresponding thermal images, which it then transmits to a separate evaluation unit, for example to a suitable PC or the like, which then evaluates the image material. In order to evaluate the material, the evaluation unit can be equipped with suitable image recognition and image evaluation software, which can automatically identify such fires from the images recorded by the camera. Software which is suitable for this purpose or can be made suitable for this purpose is known in the prior art.

The apparatus for extinguishing the fires further more comprises an extinguishant 26, specifically in this case extinguishing water. The extinguishing water 26 is stored in a suitable tank 28, at the foot of the tower 14 of the wind energy installation 10, within the same.

The extinguishing water 26 in the present case is rainwater which has been collected and which has precipitated on or in the close surrounding area of the wind energy installation 10. A rainwater cistern (not illustrated) with an appropriate container like a tank is incorporated in the ground 12, in order to collect the rainwater directly around the tower 14 of the wind energy installation 10. The rainwater enters the cistern through appropriate openings arranged in the ground 12. This applies in particular to rainwater which runs downward on the tower 14.

The rainwater is then pumped out of the cistern or out of the tank-like container thereof by means of a suitable pumping device into the extinguishant reservoir 28.

According to the invention, the wind energy installation 10 and, with the tower 14 as well as the extinguishant reservoir 28, are installed on a raised area 30 on the ground 12. Starting from the raised area 30, the terrain in the present case falls downward in all vertical directions. The ground 12 on which the shrubbery 22 and the trees 24 are arranged is in this case arranged under the raised area 30, and therefore under the extinguishant reservoir 28. In this case, the terrain has a slight gradient 31 in the area 33 between the raised area 30 and the shrubbery/trees 22, 24.

In the present example, the surface of the intermediate area 33 with the gradient 31 is secured artificially, specifically by means of a suitable sealing layer 34, which in this case is formed by paving slabs 34. The sealing layer 34 is used to make the ground 12 as impermeable to water as possible in this intermediate area 33, as a result of which water can flow downward along the gradient 31, along this intermediate area, as far as possible without seeping away into the ground 12. This will be explained in more detail in the following text.

The extinguishing method according to the invention will be explained in more detail in the following text:

First of all, the detection device or the thermal imaging camera 20 continuously monitors the shrubbery 22 and trees 24 for the occurrence of a fire.

As soon as the detection device 20 detects a fire source 32 in the area of the shrubbery 22 or of the trees 24, it produces an appropriate electronic signal, which represents the fire 32.

This signal is then transmitted to a control device, which is not illustrated, for the apparatus in order to extinguish fires.

The control device in turn controls suitable valves, which are associated with the extinguishant reservoir 28 and by means of which outlet openings in the extinguishant reservoir 28 can be closed and opened.

After receiving the signal which represents the fire 32, the control device opens the valves in the extinguishant reservoir 28, as a result of which the extinguishing water 26 stored therein can emerge and flows along the gradient 31 in the direction of the fire 32. In other words, the area 32 of the shrubbery 22 and trees 24 which is burning is flooded with the extinguishing water 26 from the extinguishant reservoir 28, in order to extinguish the fire. In this case, the sealing layer 34 assists the process of passing water in the direction of the fire 32 in that it at least largely prevents the water from seeping away into the ground 12 in the intermediate area 33.

Various alternative or additional embodiments are, of course, feasible for passing extinguishing water 26 out of the extinguishant reservoir 28 in the direction of the respective fire. For example, nozzles associated with the extinguishant reservoir can accelerate the extinguishing water out of the extinguishant reservoir 28 in the desired direction. Furthermore, the extinguishing water can initially, in principle, be carried in one or more pipelines which originate from the extinguishant reservoir 28 and whose open ends end shortly before the shrubbery 22 or trees 24, such that the extinguishing water flows out of these open pipe ends. As a person skilled in the prior art knows, there are many feasible options.

### LIST OF DESIGNATIONS

10 wind energy installation

12 ground

14 tower

16 rotor

18 rotor blades

20 Thermal imaging camera

22 shrubbery

24 trees

26 extinguishant

28 extinguishant reservoir

30 raised area

31 gradient

32 fire

33 intermediate area

34 paving slabs

What is claimed is:

1. Method for automatically extinguishing fires on a wind energy installation or in the surrounding area of a wind energy installation, in which the wind energy installation (10) and/or the surrounding area of the wind energy installation (10) are/is monitored for the occurrence of a fire (32) by means of a suitable detection device, and by means of which, after the detection of a corresponding fire (32), an extinguishant (26), preferably water, is passed out of an extinguishant reservoir (28), which is associated with the wind energy installation (10), in the direction of the fire location.

2. Wind energy installation having an apparatus for automatically extinguishing fires on a wind energy installation or in the surrounding area of the wind energy installation, in particular for carrying out the method according to claim 1, having a detection device by means of which the wind energy installation (10) and/or the surrounding area of the wind energy installation (10) can be monitored for the occurrence of a fire (32), and having a reservoir (28), which is associated with the wind energy installation (10), for an extinguishant (26), from which the extinguishant (26) can be passed automatically in the direction of the fire location after detection of a corresponding fire (32).

3. Wind energy installation according to claim 2, characterized in that the detection device has a thermal imaging camera (20) which is preferably arranged on the tower of the wind energy installation.

4. Wind energy installation according to one or more of claims 2-3, characterized in that the extinguishant reservoir (28) is positioned higher than potential fire sources (32) arranged in the surrounding area of the reservoir (28), such that, after the detection of a corresponding fire (32), liquid extinguishant (26) can flow out of the extinguishant reservoir (28) along a gradient (31) in the direction of the fire sources (32) arranged further below.

5. Wind energy installation according to claim 4, characterized in that the extinguishant reservoir (28) is positioned on a raised area (30) within a correspondingly designed terrain area in which the extinguishant reservoir (28) is arranged.

6. Wind energy installation according to claim 5, characterized in that the tower (14) of the wind energy installation (10) is likewise arranged on the raised area (30).

7. Wind energy installation according to one or more of claims 2-6, characterized in that the extinguishant reservoir (28) is arranged in the interior of the tower (14) of the wind energy installation.

8. Wind energy installation according to one or more of the preceding claims 5-7, characterized in that the terrain which is adjacent to the raised area (30) in the terrain area has a gradient (31) at least in places, preferably in a specific circumferential area around the tower (14) and extinguishant reservoir (28), along which the liquid extinguishant (26), preferably water, can flow to the potential fire sources (32).

9. Wind energy installation according to one or more of the preceding claims 5-8, characterized in that the wind energy installation (10) has at least one associated rainwater catchment container, in which rainwater, which can be used as extinguishant (26) and falls at the location of the wind energy installation (10) or in the immediate surrounding area of the wind energy installation (10), can be collected.

10. Wind energy installation according to claim 9, characterized in that openings in a rainwater cistern, which is incorporated in the ground, are incorporated in the ground adjacent to the tower (14) of the wind energy installation (10), through which the rainwater which runs off the tower (14) of the wind energy installation (10) can enter the cistern.

11. Wind energy installation according to one or more of the preceding claims 9-10, characterized in that the rainwater catchment container is the extinguishant reservoir (28), from which the extinguishant (26) can be passed in the direction of the fire sources (32), or in that the water can be fed from the rainwater catchment container into the extinguishant reservoir (28) by means of suitable feed devices.

12. Wind energy installation according to one or more of the preceding claims 2-11, characterized in that the extinguishant reservoir (28) has at least one associated valve which can be controlled by means of a control device and by means of which an outlet-flow opening, which is associated with the extinguishant reservoir (28), can be closed or opened, through which the extinguishant (26) can flow out of the extinguishant reservoir (28) when required.

13. Wind energy installation according to claim 12, characterized in that a suitable signal can be transmitted to the control device from the detection device after detection of a fire (32), and in that the valve can be opened by the control device after receiving the signal.

14. Method for automatically extinguishing fires on a wind energy installation or in the surrounding area of a wind energy installation, in which the wind energy installation (10) and/or the surrounding area of the wind energy installation (10) are/is monitored for the occurrence of a fire (32) by means of a suitable detection device, and by means of which, after the detection of a corresponding fire (32), a liquid extinguishant (26) is passed out of an extinguishant reservoir (28)—which is associated with the wind energy installation (10) and which is arranged on a raised area in a position higher than potential fires sources (32) arranged in the surrounding area of the reservoir (28)—along a gradient (31) in the direction of the fire sources (32), which are arranged further below.

15. Wind energy installation having an apparatus for automatically extinguishing fires on a wind energy installation or in the surrounding area of the wind energy installation for carrying out the method according to claim 1, having a detection device by means of which the wind energy installation (10) and/or the surrounding area of the wind energy installation (10) can be monitored for the occurrence of a fire (32), and having a reservoir (28), which is associated with the wind energy installation (10) and arranged on a raised area (30), for an extinguishant (26), from which the extinguishant (26) can be passed automatically in the direction of the fire location after detection of a corresponding fire (32), with the extinguishant reservoir (28) being positioned higher than potential fire sources (32) arranged in the surrounding area of the reservoir (28), such that, after the detection of a corresponding fire (32), liquid extinguishant (26) can flow out of the extinguishant reservoir (28) along a gradient (31) in the direction of the fire sources (32), which is arranged further below.

16. Wind energy installation according to claim 14 or 15, characterized in that the detection device has a thermal imaging camera (20) which is preferably arranged on the tower of the wind energy installation.

17. Wind energy installation according to claim 14 or 15, characterized in that the raised area (30) on which the extinguishant reservoir (28) is arranged, is located within a correspondingly designed terrain area.

18. Wind energy installation according to claim 14 or 15, characterized in that the tower (14) of the wind energy installation (10) is likewise arranged on the raised area (30).

19. Wind energy installation according to claim 14 or 15, characterized in that the extinguishant reservoir (28) is arranged in the interior of the tower (14) of the wind energy installation.

20. Wind energy installation according to claim 17, characterized in that the terrain which is adjacent to the raised area (30) in the terrain area has a gradient (31) at least in places, preferably in a specific circumferential area around the tower (14) and extinguishant reservoir (28), along which the liquid extinguishant (26), preferably water, can flow to the potential fire sources (32).

21. Wind energy installation according to claim 14 or 15, characterized in that the wind energy installation (10) has at least one associated rainwater catchment container, in which rainwater which can be used as extinguishant (26) and falls at the location of the wind energy installation (10) or in the immediate surrounding area of the wind energy installation (10) can be collected.

22. Wind energy installation according to claim 21, characterized in that openings in a rainwater cistern, which is incorporated in the ground, are incorporated in the ground adjacent to the tower (14) of the wind energy installation (10), through which the rainwater which runs off the tower (14) of the wind energy installation (10) can enter the cistern.

23. Wind energy installation according to claim 21, characterized in that the rainwater catchment container is the extinguishant reservoir (28), from which the extinguishant (26) can be passed in the direction of the fire sources (32), or in that the water can be fed from the rainwater catchment container into the extinguishant reservoir (28) by means of suitable feed devices.

24. Wind energy installation according to claim 14 or 15, characterized in that the extinguishant reservoir (28) has at least one associated valve which can be controlled by means of a control device and by means of which an outlet-flow opening, which is associated with the extinguishant reservoir (28), can be closed or opened, through which the extinguishant (26) can flow out of the extinguishant reservoir (28) when required.

25. Wind energy installation according to claim 24, characterized in that a suitable signal can be transmitted to the control device from the detection device after detection of a fire (32), and in that the valve can be opened by the control device after receiving the signal.
